(19) United States
(12) Patent Application Publication
(10) Pub. No.: US 2024/0235145 A9
(43) Pub. Date: Jul. 11, 2024

(54) DIVIDED-PULSE LASER REGENERATION AMPLIFICATION APPARATUS AND METHOD

(71) Applicants: Chongqing Huapu Intelligent Equipment Co., Ltd., Chongqing (CN); Chongqing Huapu Scientific Instrument Co.,Ltd., Chongqing (CN); Yunnan Huapu quantum Material Co., Ltd, Kunming (CN); ROI Optoelectronics Technology CO, LTD., Shanghai (CN); GuangDong ROI Optoelectronics Technology Co., Ltd., Dongguan (CN); Chongqing Institute of East China Normal University, Chongqing (CN); East China Normal University, Shanghai (CN)

(72) Inventors: Heping ZENG, Chongqing (CN); Zhengru GUO, Chongqing (CN); Xiaowei QIAN, Chongqing (CN); Tingting LIU, Chongqing (CN); Tianjun YAO, Chongqing (CN)

(21) Appl. No.: 18/489,083

(22) Filed: Oct. 18, 2023

(30) Foreign Application Priority Data
Oct. 19, 2022 (CN) 202211280824.X

(51) Int. Cl. H01S 3/102; H01S 3/06; H01S 3/08; H01S 3/081

(52) U.S. Cl. CPC H01S 3/1024; H01S 3/0602; H01S 3/08054; H01S 3/08059; H01S 3/0816

(57) ABSTRACT

A divided-pulse laser regeneration amplification apparatus includes: a signal light coupling component including a first half-wave plate, a first polarization beam splitter, a first Faraday rotator and a second half-wave plate placed in sequence; and a divided-pulse laser regeneration amplification component including a second polarization beam splitter and a third reflector, the second polarization beam splitter is adjacent to the second half-wave plate and is in a same column as the third reflector and the second half-wave plate; a first quarter-wave plate, a Pockels cell and a first reflector are successively arranged on a first side of the second polarization beam splitter, and a third half-wave plate, a first pulse polarization separation component and a first non-linear pulse amplification component are successively arranged on a second side of the second polarization beam splitter.

### CROSS-REFERENCE TO RELATED APPLICATION

This application claims priority to Chinese Patent Application No. 202211280824.X, filed on Oct. 19, 2022, the entire disclosure of which is incorporated herein by reference.

### TECHNICAL FIELD

The present disclosure relates to the field of ultrafast laser technology, and in particular to a divided-pulse laser regeneration amplification apparatus and method.

### BACKGROUND

The development of ultrafast optics and high-field laser technology provides new opportunities for the development of many frontier research and applications in physics and information science, and has become one of the most active research frontiers in related arts. Laser source developed based on the ultrafast optical fiber and high-field laser technology has been implemented in key areas of national economy and people's livelihood, such as industrial processing, medical surgery, time-frequency transmission and so on, due to its ultra-strong peak power, ultra-fast action process, and ultra-high resolution accuracy. Moreover, it will drive the development of certain high-tech industries in the future and promote the development and progress of many fields such as chemistry, materials science, condensed matter physics, nanoscience, biology, medical science, etc.

Currently, the mainstream technology for obtaining ultrafast femtosecond lasers with high peak power (in a megawatt level, 1 MW=10⁶ W) and high energy (in a millijoule level, 1 mJ=10-3 J) is a chirped regeneration amplification technology or a chirped pulse multipass amplification technology based on a Yb-containing material. The chirped pulse amplification technology was proposed and demonstrated by Gerard Mourou and Donna Strickland in 1985. Based on the concept of time-for-power conversion, a seed pulse is firstly expanded in time domain, and then the pulse is amplified to avoid the time-frequency domain distortion and laser damage caused by high peak power amplification pulse in an amplifier, and finally the amplified pulse is compressed in the time domain. This technology has increased the peak laser power by nearly 6 orders of magnitude, reaching a petawatt level (1 PW=10¹² W), and was awarded by the Nobel Prize in Physics in 2018. However, in the chirped amplification system, pulse broadening weakens the nonlinear effect in the amplification process, and the adverse effect of laser pulse gain narrowing is highlighted, resulting in a limited output pulse width, typically above 300 fs. Furthermore, chirped pulse amplification relies on optical fibers or spatial dispersion media (such as a large number of optical fibers, chirped fiber gratings with large dispersion, spatial diffraction gratings, etc.) to modulate the seed pulse in the time domain, which is expensive and bulky, affecting the practical application of laser amplifiers.

Divided-pulse amplification technology subjects the seed light to spatial beam splitting and time domain delay through means such as polarization and mirrors based on the concept of space-for-output power (pulse energy) conversion to form 2n sub-pulse sequences, and at the same time, it can reduce the peak power in the pulse amplification process and avoid nonlinear accumulation and amplifier damage. At present, divided-pulse amplification technology is commonly used in fiber laser amplifiers, with limited output energy.

### SUMMARY

Embodiments of the present disclosure provide a divided-pulse laser regeneration amplification apparatus. The divided-pulse laser regeneration amplification apparatus includes: a signal light coupling component and a divided-pulse laser regeneration amplification component. The signal light coupling component includes a first half-wave plate, a first polarization beam splitter, a first Faraday rotator and a second half-wave plate placed in sequence. The divided-pulse laser regeneration amplification component includes a second polarization beam splitter and a third reflector. The second polarization beam splitter is adjacent to the second half-wave plate and is in a same column as the third reflector and the second half-wave plate. A first quarter-wave plate, a Pockels cell and a first reflector are successively arranged on a first side of the second polarization beam splitter, and a third half-wave plate, a first pulse polarization separation component and a first non-linear pulse amplification component are successively arranged on a second side of the second polarization beam splitter. The first pulse polarization separation component includes m polarization separation components arranged at same intervals, where m≥2. Each of the m polarization separation components includes a polarization beam splitter, and a quarter-wave plate and a reflector successively arranged at each of two sides of the polarization beam splitter. A vertical distance between two reflectors in each of the m polarization separation components increases successively in a direction from the first pulse polarization separation component to the first non-linear pulse amplification component. The divided-pulse laser regeneration amplification component is configured to: implement first pulse beam splitting, twice laser amplifications and first pulse beam-combining of signal light injected by the signal light coupling component through a reflection path formed by the second polarization beam splitter, the first quarter-wave plate, the Pockels cell, the first reflector, the Pockels cell, the first quarter-wave plate, the second polarization beam splitter, the third half-wave plate, the first pulse polarization separation component, the first non-linear pulse amplification component, the first pulse polarization separation component, the third half-wave plate and the second polarization beam splitter to obtain combined pulse signal light; implement second pulse beam splitting, twice laser regeneration amplifications and second pulse beam-combining of the signal light by reflecting the combined pulse signal light via the third reflector to the second polarization beam splitter, and then passing through a transmission path formed by the third half-wave plate, the first pulse polarization separation component, the first non-linear pulse amplification component, the first pulse polarization separation component, the third half-wave plate and the second polarization beam splitter; and transmit the signal light through the second polarization beam splitter and re-inject the signal light into the Pockels cell, to complete one regeneration amplification cycle of the signal light. The signal light coupling component is configured to: inject a seed pulse into the divided-pulse laser regeneration amplification component; and output regenerated and amplified laser pulse beam by allowing the regenerated and amplified laser pulse beam to pass through the second half-wave plate and the first Faraday rotator of the signal light coupling component and then be reflected by the first polarization beam splitter, after the signal light reaches gain saturation through multiple regeneration amplification cycles in the divided-pulse laser regeneration amplification component.

Embodiments of the present disclosure provide a divided-pulse laser regeneration amplification method. The divided-pulse laser regeneration amplification method includes:
S1, inputting a signal light, including injecting a ps-level seed pulse into a divided-pulse laser regeneration amplification component via a signal light coupling component, where the signal light coupling component includes a first half-wave plate, a first polarization beam splitter, a first Faraday rotator and a second half-wave plate placed in sequence; the divided-pulse laser regeneration amplification component includes a second polarization beam splitter and a third reflector, the second polarization beam splitter is adjacent to the second half-wave plate and is in a same column as the third reflector and the second half-wave plate; a first quarter-wave plate, a Pockels cell and a first reflector are successively arranged on a first side of the second polarization beam splitter, and a third half-wave plate, a first pulse polarization separation component and a first non-linear pulse amplification component are successively arranged on a second side of the second polarization beam splitter, the first pulse polarization separation component includes m polarization separation components arranged at same intervals, where m≥2, each of the m polarization separation components includes a polarization beam splitter, and a quarter-wave plate and a reflector successively arranged at each of two sides of the polarization beam splitter, and a vertical distance between two reflectors in each of the m polarization separation components increases successively in a direction from the first pulse polarization separation component to the first non-linear pulse amplification component;
S2, performing polarization, beam splitting and pulse separation on the signal light in the divided-pulse laser regeneration amplification component, in which when performing the polarization and beam splitting on the signal light, the signal light firstly reaches the second polarization beam splitter to reflect S-polarized light, then passes through the first quarter-wave plate and the Pockels cell in sequence, and is reflected by the first reflector; a switching period of the Pockels cell is controlled in such a manner that the S-polarized light reflected by the first reflector is changed into P-polarized light after passing through the first quarter-wave plate; after the P-polarized light transmits through the second polarization beam splitter, a polarization direction of the P-polarized light is rotated by a set angle by the third half-wave plate, such that the signal light is equally divided into P-polarized light and S-polarized light to achieve the beam splitting of the signal light; the polarized lights after the beam splitting are injected into the first pulse polarization separation component for pulse separation, and divided by the m polarization separation components of the first pulse polarization separation component into 2^{m} sub-pulses with orthogonal polarization between adjacent sub-pulses and with time delay between sub-pulses;
S3, amplifying the signal light, including: injecting the sub-pulses into the first non-linear pulse amplification component, and performing twice pulse signal amplifications and rotating a polarization direction of the sub-pulses by 90° in the first non-linear pulse amplification component to obtain amplified sub-pulses, and then the amplified sub-pulses being returned along an original path;
S4, polarizing and beam-combining the amplified sub-pulses, including: re-injecting the amplified sub-pulses into the first pulse polarization separation component for polarizing and beam-combining to obtain a single amplified pulse signal light in an S polarization state;
S5, regenerating and amplifying the single amplified pulse signal light, including: the amplified pulse signal light being reflected to the third reflector by the second polarization beam splitter, and reflected back to the second polarization beam splitter by the third reflector, and then successively passing through the third half-wave plate and the first pulse polarization separation component to perform the polarization, beam splitting and pulse separation, and then passing through the first non-linear pulse amplification component for amplification, and being reflected by the first non-linear pulse amplification component to the first pulse polarization separation component to perform second pulse beam-combining to obtain combined signal light which is changed back to the P-polarized state again, and then the combined signal light transmitting through the second polarization beam splitter and re-injected into the Pockels cell to complete one regeneration amplification cycle; and
S6, controlling the switching period of the Pockels cell, repeating the steps S2-S5 of the regeneration amplification cycle on the signal light until gain saturation to obtain regenerated and amplified laser pulse beam, then passing the regenerated and amplified laser pulse beam through the second half-wave plate and the first Faraday rotator of the signal light coupling component, and reflecting the regenerated and amplified laser pulse beam by the first polarization beam splitter to output the regenerated and amplified laser pulse beam.

### BRIEF DESCRIPTION OF THE DRAWINGS

FIG. 1 is a schematic structural diagram illustrating a one-way divided-pulse laser regeneration amplification apparatus according to Embodiment 1;

FIG. 2 is a schematic structural diagram illustrating a one-way divided-pulse laser regeneration amplification apparatus with a non-linear amplification compound loop mirror according to Embodiment 2;

FIG. 3 is a schematic structural diagram illustrating a one-way divided-pulse laser regeneration amplification apparatus with a non-linear amplification compound loop mirror according to Embodiment 3;

FIG. 4 is a schematic structural diagram illustrating a divided-pulse laser regeneration amplification apparatus with a dispersion-compensated non-linear amplification compound loop mirror according to Embodiment 4;

FIG. 5 is a schematic structural diagram illustrating a two-path divided-pulse laser regeneration amplification apparatus with same gain crystal element in the two regeneration amplification paths according to Embodiment 5;

FIG. 6 is a schematic structural diagram illustrating a two-path divided-pulse laser regeneration amplification apparatus with two different gain crystal elements in the two regeneration amplification paths according to Embodiment 6;

FIG. 7 is a schematic structural diagram illustrating a first pulse polarization separation component 206 according to embodiments of the present disclosure;

FIG. 8 is a schematic structural diagram illustrating an arrangement of two gain crystal elements in different directions according to Embodiment 6; and

FIG. 9 is a schematic diagram illustrating a pulse amplification evolution process according to embodiments of the present disclosure.

### DETAILED DESCRIPTION

In order to make embodiments and advantages of the present disclosure more clear, embodiments of the present disclosure will be clearly and completely described below with reference to the accompanying drawings. It will be apparent that the described embodiments are some, but not all embodiments of the present disclosure. The components generally described in embodiments of the present disclosure and illustrated in the accompanying drawings may be arranged and designed in a variety of different configurations. Accordingly, the following detailed description of embodiments of the present disclosure with reference to the accompanying drawings is not intended to limit the protection scope of the present disclosure, but for better understanding of embodiments of the present disclosure. All other embodiments obtainable by those skilled in the art based on the embodiments of the present disclosure without inventive effort fall within the protection scope of the present disclosure.

It should be noted that like numerals and letters denote similar components in the accompanying drawings. Therefore, once a component is defined in one figure, it will not be defined and explained in other figures again. In the description of the present disclosure, it should be noted that the terms “center”, “upper”, “lower”, “left”, “right”, “vertical”, “horizontal”, “inner”, “outer” and the like should be construed to refer to an orientation or positional relationship based on the orientation or positional relationship as then described or as shown in the drawings under discussion, or the orientation or positional relationship that is usually placed when the product of the present disclosure is used. These relative terms are for convenience and simplification of description of the present disclosure and do not require that the described devices or elements have to be constructed or operated in a particular orientation. In addition, terms such as “first”, “second” and “third” are used herein for purposes of description and are not intended to indicate or imply relative importance. Furthermore, the terms “horizontal”, “vertical” and the like do not imply that a component is absolutely horizontal or vertical, but may be slightly inclined. For example, the term “horizontal” only means that the direction of a structure referred to is more horizontal than “vertical”, and it does not mean that the structure must be completely horizontal, but may be slightly inclined. In the present disclosure, unless specified or limited otherwise, the terms “disposed,” “mounted,” “connected,” “coupled,” and the like are used broadly, and may be, for example, fixed connections, detachable connections, or integral connections; may also be mechanical or electrical connections; may also be direct connections or indirect connections via intervening structures; and may also be inner communications of two elements, which can be understood by those skilled in the art according to specific situations.

Embodiments of the present disclosure provide a divided-pulse laser regeneration amplification apparatus and method, which solve the problems of high cost, large volume and limited output energy in the existing divided-pulse amplification apparatus.

Embodiments of the present disclosure provide a divided-pulse laser regeneration amplification apparatus. The divided-pulse laser regeneration amplification apparatus includes: a signal light coupling component and a divided-pulse laser regeneration amplification component. The signal light coupling component includes a first half-wave plate, a first polarization beam splitter, a first Faraday rotator and a second half-wave plate placed in sequence. The divided-pulse laser regeneration amplification component includes a second polarization beam splitter and a third reflector. The second polarization beam splitter is adjacent to the second half-wave plate and is in a same column as the third reflector and the second half-wave plate. A first quarter-wave plate, a Pockels cell and a first reflector are successively arranged on a first side of the second polarization beam splitter, and a third half-wave plate, a first pulse polarization separation component and a first non-linear pulse amplification component are successively arranged on a second side of the second polarization beam splitter. The first pulse polarization separation component includes m polarization separation components arranged at same intervals, where m≥2. Each of the m polarization separation components includes a polarization beam splitter, and a quarter-wave plate and a reflector successively arranged at each of two sides of the polarization beam splitter. A vertical distance between two reflectors in each of the m polarization separation components increases successively in a direction from the first pulse polarization separation component to the first non-linear pulse amplification component. The divided-pulse laser regeneration amplification component is configured to: implement first pulse beam splitting, twice laser amplifications and first pulse beam-combining of signal light injected by the signal light coupling component through a reflection path formed by the second polarization beam splitter, the first quarter-wave plate, the Pockels cell, the first reflector, the Pockels cell, the first quarter-wave plate, the second polarization beam splitter, the third half-wave plate, the first pulse polarization separation component, the first non-linear pulse amplification component, the first pulse polarization separation component, the third half-wave plate and the second polarization beam splitter to obtain combined pulse signal light; implement second pulse beam splitting, twice laser regeneration amplifications and second pulse beam-combining of the signal light by reflecting the combined pulse signal light via the third reflector to the second polarization beam splitter, and then passing through a transmission path formed by the third half-wave plate, the first pulse polarization separation component, the first non-linear pulse amplification component, the first pulse polarization separation component, the third half-wave plate and the second polarization beam splitter; and transmit the signal light through the second polarization beam splitter and re-inject the signal light into the Pockels cell, to complete one regeneration amplification cycle of the signal light. The signal light coupling component is configured to: inject a seed pulse into the divided-pulse laser regeneration amplification component; and output regenerated and amplified laser pulse beam by allowing the regenerated and amplified laser pulse beam to pass through the second half-wave plate and the first Faraday rotator of the signal light coupling component and then be reflected by the first polarization beam splitter, after the signal light reaches gain saturation through multiple regeneration amplification cycles in the divided-pulse laser regeneration amplification component.

In some embodiments, the first non-linear pulse amplification component includes a first gain crystal element, a second Faraday rotator and a second reflector. The second Faraday rotator is located between the first gain crystal element and the second reflector, and the first gain crystal element is adjacent to the first pulse polarization separation component.

In some embodiments, the first non-linear pulse amplification component includes a third polarization beam splitter, a first gain crystal element, a second reflector, a fourth reflector, a fourth half-wave plate and a fifth reflector. The third polarization beam splitter, the fifth reflector and the first pulse polarization separation component are arranged on a same straight line. The third polarization beam splitter is located between the fifth reflector and the first pulse polarization separation component. A beam path formed by the third polarization beam splitter, the first gain crystal element and the second reflector is perpendicular to a beam path formed by the third polarization beam splitter and the fifth reflector. The first gain crystal element is located between the third polarization beam splitter and the second reflector. The fourth reflector is arranged on a side of the second reflector, and a beam path formed by the fourth reflector, the fourth half-wave plate and the fifth reflector is parallel to the beam path formed by the third polarization beam splitter, the first gain crystal element and the second reflector.

In some embodiments, the fourth half-wave plate is replaced by a third Faraday rotator.

In some embodiments, the first non-linear pulse amplification component includes a third polarization beam splitter, a first gain crystal element, a second reflector, two pairs of reflective diffraction gratings, a fourth reflector, a third Faraday rotator and a fifth reflector. The third polarization beam splitter, the fifth reflector and the first pulse polarization separation component are arranged on a same straight line. The third polarization beam splitter is located between the fifth reflector and the first pulse polarization separation component. A beam path formed by the third polarization beam splitter, the first gain crystal element and the second reflector is perpendicular to a beam path formed by the third polarization beam splitter and the fifth reflector. The first gain crystal element is located between the third polarization beam splitter and the second reflector. The two pairs of reflective diffraction gratings are arranged between the second reflector and the fourth reflector. A beam path formed by the fourth reflector, the third Faraday rotator and the fifth reflector is parallel to the beam path formed by the third polarization beam splitter, the first gain crystal element and the second reflector.

In some embodiments, the third reflector is replaced by a second regeneration amplification component, and the second regeneration amplification component includes a sixth reflector, a fourth polarization beam splitter, a fifth half-wave plate, a second pulse polarization separation component and a second non-linear pulse amplification component arranged in sequence. The fourth polarization beam splitter corresponds to the second polarization beam splitter and is located in a same column as the second polarization beam splitter. The sixth reflector is located on the same side as the first reflector. The fifth half-wave plate and the sixth reflector are respectively located on two opposite sides of the fourth polarization beam splitter.

In some embodiments, the second non-linear pulse amplification component includes a second gain crystal element, a fourth Faraday rotator and a seventh reflector arranged in sequence.

In some embodiments, the first and second gain crystal elements include laser crystals doped with ytterbium or neodymium ions.

Embodiments of the present disclosure provide a divided-pulse laser regeneration amplification method. The divided-pulse laser regeneration amplification method includes:
S1, inputting a signal light, including injecting a ps-level seed pulse into a divided-pulse laser regeneration amplification component via a signal light coupling component, where the signal light coupling component includes a first half-wave plate, a first polarization beam splitter, a first Faraday rotator and a second half-wave plate placed in sequence; the divided-pulse laser regeneration amplification component includes a second polarization beam splitter and a third reflector, the second polarization beam splitter is adjacent to the second half-wave plate and is in a same column as the third reflector and the second half-wave plate; a first quarter-wave plate, a Pockels cell and a first reflector are successively arranged on a first side of the second polarization beam splitter, and a third half-wave plate, a first pulse polarization separation component and a first non-linear pulse amplification component are successively arranged on a second side of the second polarization beam splitter, the first pulse polarization separation component includes m polarization separation components arranged at same intervals, where m≥2, each of the m polarization separation components includes a polarization beam splitter, and a quarter-wave plate and a reflector successively arranged at each of two sides of the polarization beam splitter, and a vertical distance between two reflectors in each of the m polarization separation components increases successively in a direction from the first pulse polarization separation component to the first non-linear pulse amplification component;
S2, performing polarization, beam splitting and pulse separation on the signal light in the divided-pulse laser regeneration amplification component, in which when performing the polarization and beam splitting on the signal light, the signal light firstly reaches the second polarization beam splitter to reflect S-polarized light, then passes through the first quarter-wave plate and the Pockels cell in sequence, and is reflected by the first reflector; a switching period of the Pockels cell is controlled in such a manner that the S-polarized light reflected by the first reflector is changed into P-polarized light after passing through the first quarter-wave plate; after the P-polarized light transmits through the second polarization beam splitter, a polarization direction of the P-polarized light is rotated by a set angle by the third half-wave plate, such that the signal light is equally divided into P-polarized light and S-polarized light to achieve the beam splitting of the signal light; the polarized lights after the beam splitting are injected into the first pulse polarization separation component for pulse separation, and divided by the m polarization separation components of the first pulse polarization separation component into 2^{m} sub-pulses with orthogonal polarization between adjacent sub-pulses and with time delay between sub-pulses;
S3, amplifying the signal light, including: injecting the sub-pulses into the first non-linear pulse amplification component, and performing twice pulse signal amplifications and rotating a polarization direction of the sub-pulses by 90° in the first non-linear pulse amplification component to obtain amplified sub-pulses, and then the amplified sub-pulses being returned along an original path;
S4, polarizing and beam-combining the amplified sub-pulses, including: re-injecting the amplified sub-pulses into the first pulse polarization separation component for polarizing and beam-combining to obtain a single amplified pulse signal light in an S polarization state;
S5, regenerating and amplifying the single amplified pulse signal light, including: the amplified pulse signal light being reflected to the third reflector by the second polarization beam splitter, and reflected back to the second polarization beam splitter by the third reflector, and then successively passing through the third half-wave plate and the first pulse polarization separation component to perform the polarization, beam splitting and pulse separation, and then passing through the first non-linear pulse amplification component for amplification, and being reflected by the first non-linear pulse amplification component to the first pulse polarization separation component to perform second pulse beam-combining to obtain combined signal light which is changed back to the P-polarized state again, and then the combined signal light transmitting through the second polarization beam splitter and re-injected into the Pockels cell to complete one regeneration amplification cycle; and
S6, controlling the switching period of the Pockels cell, repeating the steps S2-S5 of the regeneration amplification cycle on the signal light until gain saturation to obtain regenerated and amplified laser pulse beam, then passing the regenerated and amplified laser pulse beam through the second half-wave plate and the first Faraday rotator of the signal light coupling component, and reflecting the regenerated and amplified laser pulse beam by the first polarization beam splitter to output the regenerated and amplified laser pulse beam.

In some embodiments, the third reflector is replaced by a second regeneration amplification component. The second regeneration amplification component includes a sixth reflector, a fourth polarization beam splitter, a fifth half-wave plate, a second pulse polarization separation component and a second non-linear pulse amplification component arranged in sequence. The fourth polarization beam splitter corresponds to the second polarization beam splitter and is located in a same column as the second polarization beam splitter. The sixth reflector is located on the same side as the first reflector. The fifth half-wave plate and the sixth reflector are respectively located on two opposite sides of the fourth polarization beam splitter. After the seed pulse is injected into the divided-pulse laser regeneration amplification component via the signal light coupling component to successively subject to the pulse separation, laser amplification and beam-combining in the steps S2-S4 to obtain a combined signal light, the combined signal light is reflected to the fourth polarization beam splitter of the second regeneration amplification component by the second polarization beam splitter, and then reflected by the fourth polarization beam splitter to the fifth half-wave plate and then successively enters the second pulse polarization separation component and the second non-linear pulse amplification component to realize pulse separation and laser amplification, and sub-pulses obtained thereby are rotated by 90° in their polarizing directions; then the sub-pulses pass through the second non-linear pulse amplification component and the second pulse polarization separation component again to realize laser amplification and pulse beam-combining to obtain a combined signal light, which transmits through the fourth polarization beam splitter and reflected by the sixth reflector to transmit through the fourth polarization beam splitter again, and then successively enters the fifth half-wave plate, the second pulse polarization separation component and the second non-linear pulse amplification component for pulse separation and amplification, then reflected by the second non-linear pulse amplification component to enter the second pulse polarization separation component for amplification and pulse beam-combining again, and then reflected by the fourth polarization beam splitter back to the second polarization beam splitter and subjected to the pulse separation, laser amplification and beam-combining in the steps S2-S4 again, and then transmits through the second polarization splitter and returns back to the Pockels cell to complete one regeneration amplification cycle.

Compared with the related art, embodiments of the present disclosure have the following advantageous effects.

1. The signal light pulse can be divided into 2^{m} sub-pulses in the pulse polarization separation component, which greatly increases the pulse duty ratio in the laser amplification process, and the pulses pass through the gain crystal many times, which is conducive to achieve higher efficiency of pulse amplification and reduce the laser power consumption.

2. The pulse separation amplification method is used without expensive diffraction gratings, chirped Bragg fiber gratings, volume Bragg gratings and other dispersion broadening media, which enables the corresponding apparatus to achieve a more compact structure and reduced cost, and realize a millijoule-level pulse output.

3. The dual-path divided-pulse regeneration amplification apparatus and method can effectively suppress the gain narrowing effect in the regeneration amplification process and obtain femtosecond pulses with higher peak power by taking advantage of the complementary characteristics of the radiation spectra of different gain crystals or different cutting directions of the same type of gain crystals.

### Embodiment 1

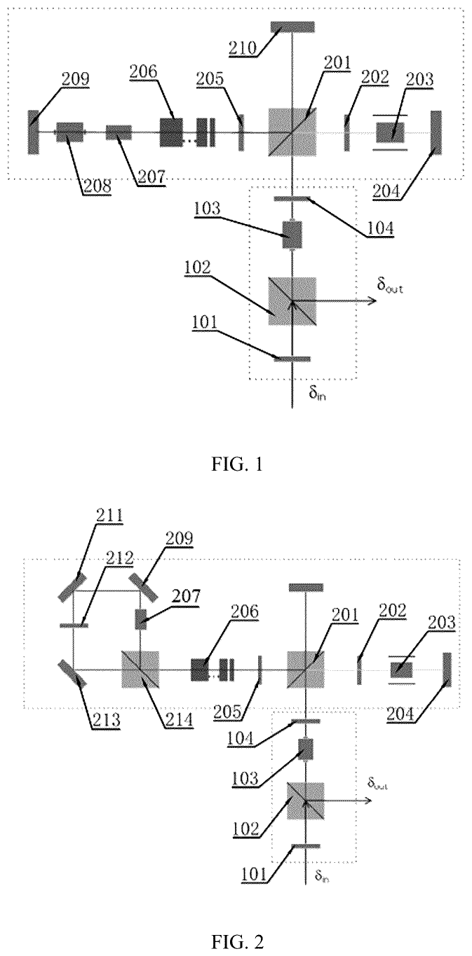

A one-way divided-pulse laser regeneration amplification apparatus is provided in this embodiment. As shown in FIG. 1, the one-way divided-pulse laser regeneration amplification apparatus includes a signal light coupling component and a divided-pulse laser regeneration amplification component. The signal light coupling component includes a first half-wave plate 101, a first polarization beam splitter 102, a first Faraday rotator 103 and a second half-wave plate 104 placed in sequence.

The divided-pulse laser regeneration amplification component includes a second polarization beam splitter 201 and a third reflector 210. The second polarization beam splitter 201 is adjacent to the second half-wave plate 104 and is in a same column as the third reflector 210 and the second half-wave plate 104. A first quarter-wave plate 202, a Pockels cell 203 and a first reflector 204 are successively arranged on a first side of the second polarization beam splitter 201, and a third half-wave plate 205, a first pulse polarization separation component 206 and a first non-linear pulse amplification component are successively arranged on a second side of the second polarization beam splitter 201.

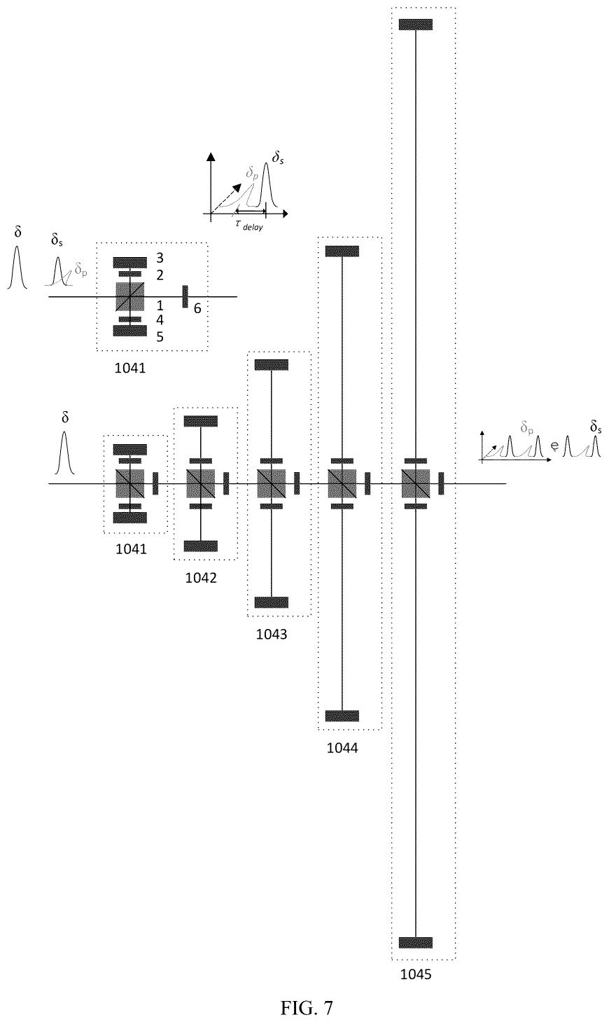

The first pulse polarization separation component 206 includes 5 polarization separation components arranged at same intervals (as shown in FIG. 7), each polarization separation component includes a polarization beam splitter 1, and a quarter-wave plate (marked by 2 or 4 in the FIG. 7) and a reflector (marked by 3 or 5 in the FIG. 7) successively arranged at each of two sides of the polarization beam splitter. A vertical distance between two reflectors in each of the 5 polarization separation components increases successively from the first pulse polarization separation component to the first non-linear pulse amplification component. For example, as shown in FIG. 7, the vertical distance between two reflectors of the first polarization separation component is 1=8 mm, and the vertical distances 1 of subsequent polarization separation components are successively multiplied.

In this embodiment, the divided-pulse laser regeneration amplification method of the one-way divided-pulse laser regeneration amplification apparatus includes:
S1, inputting a signal light, including injecting a ps-level seed pulse into the divided-pulse laser regeneration amplification component via the signal light coupling component;
S2, performing polarization, beam splitting and pulse separation on the signal light in the divided-pulse laser regeneration amplification component, in which when performing the polarization and beam splitting on the signal light, the signal light firstly reaches the second polarization beam splitter 201 to reflect S-polarized light, then passes through the first quarter-wave plate 202 and the Pockels cell 203 in sequence, and is reflected by the first reflector 204; a switching period of the Pockels cell 203 is controlled in such a manner that the S-polarized light reflected by the first reflector 204 is changed into P-polarized light after passing through the first quarter-wave plate 202; after the P-polarized light transmits through the second polarization beam splitter 201, a polarization direction of the P-polarized light is rotated by a set angle by the third half-wave plate 205, such that the signal light is equally divided into P-polarized light and S-polarized light to achieve beam splitting of the signal light; the polarized lights after the beam splitting are injected into the first pulse polarization separation component for pulse separation, and divided by the 5 polarization separation components of the first pulse polarization separation component into 32 sub-pulses with orthogonal polarization between adjacent sub-pulses and with time delay between sub-pulses;
S3, amplifying the signal light, including: injecting the sub-pulses into the first non-linear pulse amplification component, and performing twice pulse signal amplifications and rotating a polarization direction of the sub-pulses by 90° in the first non-linear pulse amplification component to obtain amplified sub-pulses, and then the amplified sub-pulses being returned along an original path;
S4, polarizing and beam-combining the amplified sub-pulses, including: re-injecting the amplified sub-pulses into the first pulse polarization separation component for polarizing and beam-combining to obtain a single amplified pulse signal light in an S polarization state;
S5, regenerating and amplifying the single amplified pulse signal light, including: the amplified pulse signal light being reflected to the third reflector 310 by the second polarization beam splitter 201, and reflected back to the second polarization beam splitter 201 by the third reflector 210, and then successively passing through the third half-wave plate 205 and the first pulse polarization separation component to perform the polarization, beam splitting and pulse separation, and then passing through the first non-linear pulse amplification component for amplification, and being reflected by the first non-linear pulse amplification component to the first pulse polarization separation component to perform second pulse beam-combining to obtain combined signal light which is changed back to the P-polarized state again, and then the combined signal light transmitting through the second polarization beam splitter 201 and re-injected into the Pockels cell 203 to complete one regeneration amplification cycle (a single regeneration amplification cycle include twice pulse beam splitting, twice beam-combining, and four times of energy amplifications, thereby greatly improving the amplification efficiency); and
S6, controlling the switching period of the Pockels cell 203, repeating the steps S2-S5 of the regeneration amplification cycle on the signal light until gain saturation to obtain regenerated and amplified laser pulse beam, then passing the regenerated and amplified laser pulse beam through the second half-wave plate 104 and the first Faraday rotator 103 of the signal light coupling component, and reflecting the regenerated and amplified laser pulse beam by the first polarization beam splitter 102 to output the regenerated and amplified laser pulse beam.

As shown in FIG. 7, taking a single pulse separation process as an example, the signal light δ is linearly polarized, with a pulse width τ=10 ps, and a polarization direction at 45° to an upper surface of the polarization beam splitter, which can be decomposed into abs sub-pulse vertical to an interface and a δp sub-pulse parallel to the interface, with only the pulse energy being halved compared with the signal light δ, and other parameters being unchanged. When the signal light δ is incident on the polarization beam splitter 1, the δs sub-pulse and the δp sub-pulse are reflected and transmitted by the polarization beam splitter, respectively. In the reflection path, the δs sub-pulse passes through the quarter-wave plate 2 and the reflector 3, and then is returned back along an original path. By properly adjusting the rotation angle of the quarter-wave plate, the δs sub-pulse is modulated into P-light, and transmits through the polarization beam splitter to the quarter-wave plate 4 and the reflector 5, and then be reflected again. Similarly, by adjusting the rotation angle of the quarter-wave plate 4, the P-polarized δs sub-pulse is re-modulated into S-light, and reflected by the polarization beam splitter 1 to spatially combine and be collinearly output with the δp sub-pulse that has not undergone delay. Since the δs sub-pulse experiences a longer optical path, it lags the δp sub-pulse in time, with a lag time τ_{delay}=2(np−1)dp/c+4(nw−1)dw/c+21/c=76.6 ps.

After the combined δs sub-pulse and δp sub-pulse pass through the half-wave plate 6, their respective deflection angles are rotated by 45° again, and then the δs sub-pulse and the δp sub-pulse are incident on a second polarization separation component to further split into 4 sub-pulses. After passing through 5 polarization separation components, a pulse sequence of 32 sub-pulses with orthogonal polarization between adjacent sub-pulses (i.e., the δp sub-pulse and the δs sub-pulse) and a pulse delay of 76.6 ps is obtained.

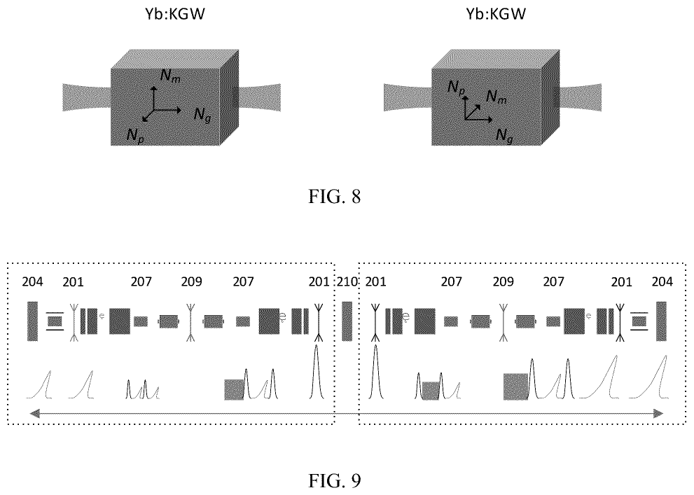

Specifically, the divided-pulse laser regeneration amplification component is configured to: implement first pulse beam splitting, twice laser amplifications and first pulse beam-combining of the signal light injected by the signal light coupling component through a reflection path formed by the second polarization beam splitter 201, the first quarter-wave plate 202, the Pockels cell 203, the first reflector 204, the Pockels cell 203, the first quarter-wave plate 202, the second polarization beam splitter 201, the third half-wave plate 205, the first pulse polarization separation component 206, the first non-linear pulse amplification component, the first pulse polarization separation component 206, the third half-wave plate 205 and the second polarization beam splitter 201 to obtain combined pulse signal light; implement second pulse beam splitting, twice laser regeneration amplifications and second pulse beam-combining of the signal light by reflecting the combined pulse signal light via the third reflector 210 to the second polarization beam splitter 201, and then passing through a transmission path formed by the third half-wave plate 205, the first pulse polarization separation component 206, the first non-linear pulse amplification component, the first pulse polarization separation component 206, the third half-wave plate 205 and the second polarization beam splitter 201; and then transmit the signal light through the second polarization beam splitter 201 and re-inject the signal light into the Pockels cell 203, to complete one regeneration amplification cycle of the signal light (specifically refer to FIG. 1 and FIG. 9).

The signal light coupling component is configured to: inject the seed pulse into the divided-pulse laser regeneration amplification component; and output regenerated and amplified laser pulse beam by allowing the regenerated and amplified laser pulse beam to pass through the second half-wave plate 104 and the first Faraday rotator 103 of the signal light coupling component and then be reflected by the first polarization beam splitter 102, after the signal light reaches gain saturation through multiple regeneration amplification cycles in the divided-pulse laser regeneration amplification component.

In this embodiment, the first non-linear pulse amplification component includes a first gain crystal element 207, a second Faraday rotator 208 and a second reflector 209. The second Faraday rotator 208 is located between the first gain crystal element 207 and the second reflector 209, and the first gain crystal element 207 is adjacent to the first pulse polarization separation component. The first gain crystal element 207 preferably includes a Yb:CaF₂ crystal with a size of 3 mm×10 mm×10 mm and a flat angle cutting direction, an anti-reflection film for a band of 950 to 1100 nm is evaporated on the transparent surface, and the doping concentration of ytterbium ions is 3.at %. Under 976 nm LD pumping, the signal light of 1030 nm can be effectively gained to realize the power amplification and energy improvement of the signal light.

The second Faraday rotator 208 is able to rotate the polarization angle of incident linearly polarized light by 45°, which can realize the separation and isolation of incident light and exit light in cooperation with the third half-wave plate 205 and the second polarization beam splitter 201, and can be used as a Faraday reflector in cooperation with a reflector, so that the incident laser is rotated by 90° in the polarization direction and then returns back along the original path.

In this embodiment, all lenses and optical elements work in a wavelength band of 1030 nm, with high reflection or transmission efficiency. Both the half-wave plate and the quarter-wave plate are phase delay plates in the band of 1030 nm, which can modulate the polarization direction of the linearly polarized laser. The thickness is dw=0.5 mm, and the refractive index is nw=1.5.

The first polarization beam splitter 102 and the second polarization beam splitter 201 are both polarized laser separation devices based on a multilayer dielectric polarization beam splitting film, which reflect the S-polarized light and transmit the P-polarized light. The polarization beam splitters 102 and 201 each have a polarization extinction ratio of >2000:1, a cube structure, a thickness of dp=5 mm, and a refractive index of np=1.6.

The first reflector, the second reflector and the third reflector each have a working wavelength band of 1000 to 1100 nm, a working angle of 0°, and a reflectivity of >99.5%. The three reflectors form a stable regenerative resonant cavity. The first reflector, the second reflector and the third reflector in this embodiment do not refer to a single lens, and may be a combination of a multi-surface plano-concave reflector or a plane reflector to form a low-loss regenerative standing wave cavity.

The Pockels cell 203 in this embodiment is a quarter-wave fast electro-optical device, which behaves as a quarter-wave plate at a high voltage (>2 kV) operation. The rising and falling edges of the response time (high voltage signal) of the Pockels cell are both less than 10 ns.

The first quarter-wave plate 202 is a phase delay plate in the band of 1030 nm, which provides a quarter-wave phase delay for the orthogonal polarization components, and is used in cooperation with the Pockels cell to achieve rapid electro-optical modulation on the seed light as well as the regenerated and amplified output light, and realize laser input and output.

By controlling the switching time of the Pockels cell and performing dozens of regeneration amplification cycles, a 10 ps-level signal light pulse can be amplified to the millijoule level, and the gain narrowing effect in the regeneration amplification process can be effectively inhibited. The system does not need a traditional dispersion broadening medium, so the volume of the system is greatly reduced, and the system and the method according to embodiments of the present disclosure provide an effective alternative solution for the chirped pulse amplification technology.

The expansion of the regeneration amplification light path in the divided-pulse laser regeneration amplification component can effectively solve the limitation of gain narrowing in the regeneration amplification process and achieve higher peak power pulse output. Aimed at the problems of nonlinear accumulation, spectral gain narrowing and pulse compression in strong-field ultrafast laser amplification technology, embodiments of the present disclosure replace the traditional chirped pulse solid-state regeneration amplification technology, and no longer rely on expensive dispersion delay media to achieve pulse broadening.

### Embodiment 2

This embodiment provides a divided-pulse laser regeneration amplification apparatus with a non-linear amplification compound loop mirror. As shown in FIG. 2, the divided-pulse laser regeneration amplification apparatus includes a signal light coupling component and a divided-pulse laser regeneration amplification component. The signal light coupling component is the same as that described in Embodiment 1. The divided-pulse laser regeneration amplification component includes a second polarization beam splitter 201 and a third reflector 210, the second polarization beam splitter 201 is adjacent to the second half-wave plate 104 and is in a same column as the third reflector 210 and the second half-wave plate 104. A first quarter-wave plate 202, a Pockels cell 203 and a first reflector 204 are successively arranged on a first side of the second polarization beam splitter 201, and a third half-wave plate 205, a first pulse polarization separation component 206 and a first non-linear pulse amplification component are successively arranged on a second side of the second polarization beam splitter 201. The first non-linear pulse amplification component in this embodiment includes a third polarization beam splitter 214, a first gain crystal element 207, a second reflector 209, a fourth reflector 211, a fourth half-wave plate 212, and a fifth reflector 213 (these components constitute the non-linear amplification compound loop mirror of this embodiment, instead of the first gain crystal element in Embodiment 1, the non-linear amplification compound loop mirror can also amplify the signal light after pulse separation, rotate the polarization state by 90°, and then return pulses to the first pulse polarization separation component to implement beam-combining). The third polarization beam splitter 214, the fifth reflector 213 and the first pulse polarization separation component 206 are arranged on a same straight line, and the third polarization beam splitter 214 is located between the fifth reflector 213 and the first pulse polarization separation component. A beam path formed by the third polarization beam splitter 214, the first gain crystal element 207 and the second reflector 209 is perpendicular to a beam path formed by the third polarization beam splitter 214 and the fifth reflector 213, and the first gain crystal element 207 is located between the third polarization beam splitter 214 and the second reflector 209. The fourth reflector 211 is arranged on a side of the second reflector 209, and a beam path formed by the fourth reflector 211, the fourth half-wave plate 212 and the fifth reflector 213 is parallel to the beam path formed by the third polarization beam splitter 214, the first gain crystal element 207 and the second reflector 209.

The parameters of the first gain crystal element 207, the third polarization beam splitter 214, and the fourth half-wave plate 212 in this embodiment are the same as those in Embodiment 1. The second reflector 209, the fourth reflector 211 and the fifth reflector 213 are plane high reflectors in the band of 1030 nm, with a reflectivity >99.5% and an incidence angle of 45°.

The first pulse polarization separation component 206 in this embodiment has the same structure as that in Embodiment 1. The signal light is also divided into a sequence of 32 sub-pulses after pulse separation, the polarizations between two adjacent sub-pulses are orthogonal, which are recorded as δp and δs sub-pulses, and the delay is recorded as Tdelay.

After the pulse separation, the δp and δs sub-pulses are incident on the third polarization beam splitter 214, where the δp sub-pulse is transmitted, while δs sub-pulse is reflected. The transmitted δp sub-pulse is reflected by the fifth reflector 213 and is changed to S-polarization by the fourth half-wave plate 212, and then injected into the first gain crystal element 207 via the fourth reflector 211 and the second reflector 209 to achieve an energy boost, and finally is reflected by the third polarization beam splitter 214. On the contrary, the δs sub-pulse is first reflected by the third polarization beam splitter 214 to directly inject into the first gain crystal element 207 to realize an energy boost, then reflected by the second reflector 209 and the fourth reflector 211, and modulated by the fourth half-wave plate 212 to P-polarization, and then reflected by the fifth reflector 213 to the third polarization beam splitter 214, and finally transmitted through the third polarization beam splitter 214. It can be seen that the δp and δs sub-pulses after the pulse separation are amplified by the non-linear amplification compound loop mirror, with their respective polarization directions being rotated by 90°, and return to the first pulse polarization separation component 206 to realize pulse beam-combining, and then further subject to another split-pulse regeneration amplification cycle until obtaining an energy boost of 60 dB.

### Embodiment 3

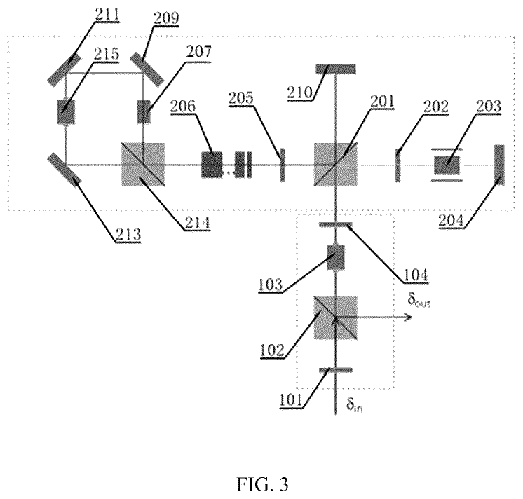

This embodiment provides a divided-pulse laser regeneration amplification apparatus with another non-linear amplification compound loop mirror, which is different from Embodiment 2 only in the first non-linear pulse amplification component. In this embodiment, shown in FIG. 3, a third Faraday rotator 215 is used to replace the fourth half-wave plate 212 in Embodiment 2 to form the divided-pulse laser regeneration amplification apparatus with the non-linear amplification compound loop mirror.

The third Faraday rotator 215 inserted in the first non-linear amplification compound loop mirror has a polarization rotation angle of 90°, which is different from the first Faraday rotator 103 in Embodiment 1.

### Embodiment 4

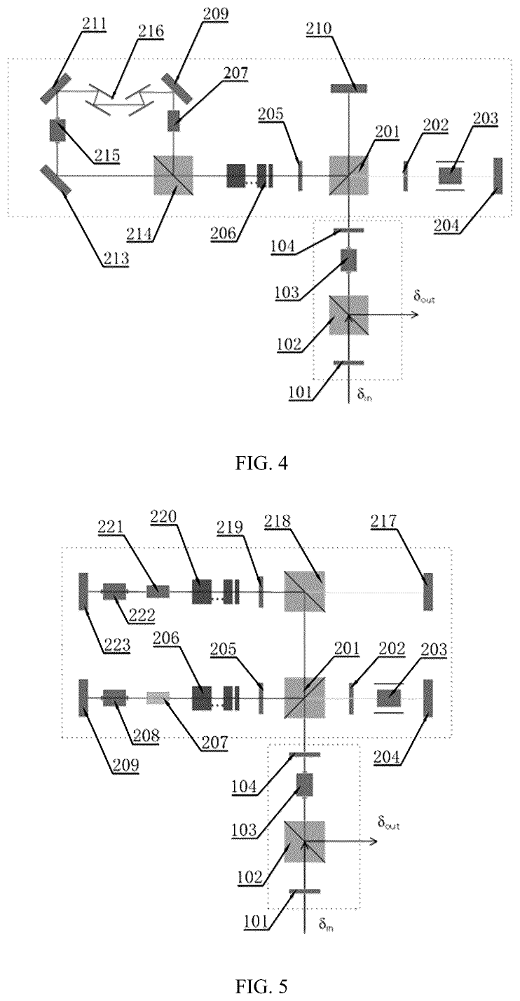

This embodiment provides a divided-pulse laser regeneration amplification apparatus with a dispersion-compensated non-linear amplification compound loop mirror, which is different from the Embodiment 3 mainly in the first non-linear pulse amplification component. Specifically, as shown in FIG. 4, the first non-linear pulse amplification component in this embodiment includes a third polarization beam splitter 214, a first gain crystal element 207, a second reflector 209, two pairs of reflective diffraction gratings 216, a fourth reflector 211, a third Faraday rotator 215 and a fifth reflector 213. The third polarization beam splitter 214, the fifth reflector 213 and the first pulse polarization separation component are arranged on a same straight line, and the third polarization beam splitter 214 is located between the fifth reflector 213 and the first pulse polarization separation component. A beam path formed by the third polarization beam splitter 214, the first gain crystal element 207 and the second reflector 209 is perpendicular to a beam path formed by the third polarization beam splitter 214 and the fifth reflector 213, and the first gain crystal element is located between the third polarization beam splitter 214 and the second reflector. The two pairs of reflective diffraction gratings 216 are arranged between the second reflector 209 and the fourth reflector 211. Abeam path formed by the fourth reflector 211, the third Faraday rotator 215 and the fifth reflector 213 is parallel to the beam path formed by the third polarization beam splitter 214, the first gain crystal element 207 and the second reflector 209.

In this embodiment, two pairs of reflective diffraction gratings are inserted in the non-linear amplification compound loop mirror to perform dispersion compensation on the signal light after pulse separation, which, in combination with the regeneration amplification process, can effectively suppress the gain narrowing effect in the high-energy pulse amplification process.

The two pairs of reflective diffraction gratings are typically featured by a working band of 1030 nm, a grating ruling period of 1250 l/mm, a grating diffraction efficiency of >90% and a Littrow angle of 42°. The arrangement of the gratings is shown in FIG. 4. A space between the gratings can be adjusted as required.

### Embodiment 5

This embodiment provides a two-path divided-pulse laser regeneration amplification apparatus with same gain crystal element in the two regeneration amplification paths. As shown in FIG. 5, the divided-pulse laser regeneration amplification apparatus includes a signal light coupling component and a divided-pulse laser regeneration amplification component. The signal light coupling component is the same as that of Embodiment 1. Compared with Embodiment 1, another divided-pulse laser regeneration amplification component is added in this embodiment. That is, the divided-pulse laser regeneration amplification apparatus in this embodiment includes a first divided-pulse laser regeneration amplification component and a second divided-pulse laser regeneration amplification component. The first divided-pulse laser regeneration amplification component includes a second polarization beam splitter 201, a first quarter-wave plate 202, a Pockels cell 203, a first reflector 204, a third half-wave plate 205, a first pulse polarization separation component 206 and a first non-linear pulse amplification component, and the arrangements of these components are the same as those in Embodiment 1, which will not be elaborated here. The second divided-pulse laser regeneration amplification component includes a sixth reflector 217, a fourth polarization beam splitter 218, a fifth half-wave plate 219, a second pulse polarization separation component 220, a second gain crystal element 221, a four Faraday rotators 222 and a seventh reflector 223 arranged in sequence. The fourth polarization beam splitter 218 corresponds to the second polarization beam splitter 201 and is located in a same column as the second polarization beam splitter 201. The sixth reflector 217 is located on the same side as the first reflector 204, and the fifth half-wave plate 219 and the sixth reflector 217 are located on two opposite sides of the fourth polarization beam splitter 218, respectively.

The first gain crystal element 207 and the second gain crystal element 221 in this embodiment are the same crystal elements. The addition of another divided-pulse laser regeneration amplification component in this embodiment helps to increase the pulse energy and suppress the gain narrowing.

The optical path evolution process of this embodiment is as follows: after a seed pulse is injected into the first divided-pulse laser regeneration amplification component via the signal light coupling component to successively subject to the pulse separation, laser amplification and beam-combining in the steps S2-S4 to obtain a combined signal light, the combined signal light is reflected to the fourth polarization beam splitter of the second divided-pulse laser regeneration amplification component by the second polarization beam splitter, and then reflected by the fourth polarization beam splitter to the fifth half-wave plate and successively enters the second pulse polarization separation component and the second non-linear pulse amplification component to realize pulse separation and laser amplification, and sub-pulses obtained thereby are rotated by 90° in their polarizing directions; then the sub-pulses pass through the second non-linear pulse amplification component and the second pulse polarization separation component again to realize laser amplification and pulse beam-combining to obtain a combined signal light, which transmits through the fourth polarization beam splitter and reflected by the sixth reflector to transmit through the fourth polarization beam splitter again, and then successively enters the fifth half-wave plate, the second pulse polarization separation component and the second non-linear pulse amplification component for pulse separation and amplification, then reflected by the second non-linear pulse amplification component to enter the second pulse polarization separation component for amplification and pulse beam-combining again, and then reflected by the fourth polarization beam splitter back to the second polarization beam splitter and subjected to the pulse separation, laser amplification and beam-combining in the steps S2-S4 again, and then transmits through the second polarization splitter and returns back to the Pockels cell to complete one regeneration amplification cycle. In this way, a single regeneration amplification cycle includes four times of pulse splitting, four times of pulse combining, and eight times of energy amplifications, which greatly improves the amplification efficiency.

After completing a regeneration amplification cycle, the switching period of the Pockels cell is precisely controlled, so that the signal light repeats the pulse separation, laser amplification, and beam-recombining in steps S2-S4 as described in Embodiment 1, and then repeats the above steps until gain saturation, and then passes through the second half-wave plate and the first Faraday rotator of the signal light coupling component, and then is reflected by the first polarization beam splitter to output the regenerated and amplified laser pulse beam.

### Embodiment 6

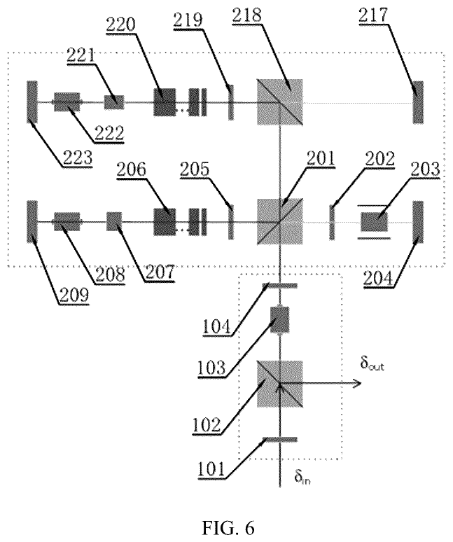

This embodiment provides a two-path divided-pulse laser regeneration amplification apparatus with two different gain crystal elements in the two regeneration amplification paths. As shown in FIG. 6, the optical paths of the apparatus in this embodiment are basically the same as that in Embodiment 5, except that the first gain crystal element 207 and the second gain crystal element 221 in this embodiment are two different gain crystal elements with two different types of gain crystals, or with the same type of gain crystal but different cutting directions or placement angles. The differences in the crystal type, cutting direction or placement angle lead to a certain degree of complementarity in the radiation spectra, which can effectively suppress the gain narrowing effect in the regeneration amplification process.

Specifically, in an embodiment, the first gain crystal element and the second gain crystal element have the same type of gain crystal but with different cutting directions. The first gain crystal element 207 has a Yb:CaF₂ crystal with a center band of the radiation spectrum of 1030 nm, and the second gain crystal element 221 has a Yb:CALGO crystal with a center band of the radiation spectrum of 1040 nm. These two gain crystal elements have a certain complementarity, so that the overall radiation spectrum band of the regenerative amplifier is broadened, and the gain narrowing can be effectively suppressed during the amplification process.

When the first gain crystal element and the second gain crystal element have the same type of gain crystal but with different placement angles, the gain crystal is Np-cut Yb:KGW crystal, the first gain crystal element 207 has an Np direction parallel to a direction of the P-polarized signal light and an Nm direction parallel to a direction of the S-polarized signal light direction, and the second gain crystal element 221 has a Np direction parallel to the direction of the S-polarized signal light and an Nm direction parallel to the direction of the P-polarized signal light, where Np, Nm and Ng are three mutually orthogonal axes of the Yb:KGW crystal, and the Ng direction is the incident direction of the signal light, as shown in FIG. 8.

It should be noted that the above embodiments are only used for illustrating the present disclosure and not for limiting the present disclosure, and it should be understood by those skilled in the art that any modifications or equivalent replacements made without departing from the spirit and scope of the present disclosure shall be covered by the scope claimed in the appended claims.

What is claimed is:

1. A divided-pulse laser regeneration amplification apparatus, comprising:
a signal light coupling component comprising a first half-wave plate, a first polarization beam splitter, a first Faraday rotator and a second half-wave plate placed in sequence; and
a divided-pulse laser regeneration amplification component comprising a second polarization beam splitter and a third reflector, wherein the second polarization beam splitter is adjacent to the second half-wave plate and is in a same column as the third reflector and the second half-wave plate; a first quarter-wave plate, a Pockels cell and a first reflector are successively arranged on a first side of the second polarization beam splitter, and a third half-wave plate, a first pulse polarization separation component and a first non-linear pulse amplification component are successively arranged on a second side of the second polarization beam splitter;
wherein the first pulse polarization separation component comprises m polarization separation components arranged at same intervals, where m≥2, each of the m polarization separation components comprises a polarization beam splitter, and a quarter-wave plate and a reflector successively arranged at each of two sides of the polarization beam splitter; and a vertical distance between two reflectors in each of the m polarization separation components increases successively in a direction from the first pulse polarization separation component to the first non-linear pulse amplification component;
wherein the divided-pulse laser regeneration amplification component is configured to: implement first pulse beam splitting, twice laser amplifications and first pulse beam-combining of signal light injected by the signal light coupling component through a reflection path formed by the second polarization beam splitter, the first quarter-wave plate, the Pockels cell, the first reflector, the Pockels cell, the first quarter-wave plate, the second polarization beam splitter, the third half-wave plate, the first pulse polarization separation component, the first non-linear pulse amplification component, the first pulse polarization separation component, the third half-wave plate and the second polarization beam splitter to obtain combined pulse signal light; implement second pulse beam splitting, twice laser regeneration amplifications and second pulse beam-combining of the signal light by reflecting the combined pulse signal light via the third reflector to the second polarization beam splitter, and then passing through a transmission path formed by the third half-wave plate, the first pulse polarization separation component, the first non-linear pulse amplification component, the first pulse polarization separation component, the third half-wave plate and the second polarization beam splitter; and then transmit the signal light through the second polarization beam splitter and re-inject the signal light into the Pockels cell, to complete one regeneration amplification cycle of the signal light;
wherein the signal light coupling component is configured to: inject a seed pulse into the divided-pulse laser regeneration amplification component; and output a regenerated and amplified laser pulse beam by allowing the regenerated and amplified laser pulse beam to pass through the second half-wave plate and the first Faraday rotator of the signal light coupling component and then be reflected by the first polarization beam splitter, after the signal light reaches gain saturation through multiple regeneration amplification cycles in the divided-pulse laser regeneration amplification component.

2. The apparatus of claim 1, wherein the first non-linear pulse amplification component comprises a first gain crystal element, a second Faraday rotator and a second reflector; the second Faraday rotator is located between the first gain crystal element and the second reflector, and the first gain crystal element is adjacent to the first pulse polarization separation component.

3. The apparatus of claim 1, wherein the first non-linear pulse amplification component comprises a third polarization beam splitter, a first gain crystal element, a second reflector, a fourth reflector, a fourth half-wave plate and a fifth reflector; the third polarization beam splitter, the fifth reflector and the first pulse polarization separation component are arranged on a same straight line, and the third polarization beam splitter is located between the fifth reflector and the first pulse polarization separation component; a beam path formed by the third polarization beam splitter, the first gain crystal element and the second reflector is perpendicular to a beam path formed by the third polarization beam splitter and the fifth reflector, and the first gain crystal element is located between the third polarization beam splitter and the second reflector; the fourth reflector is arranged on a side of the second reflector, and a beam path formed by the fourth reflector, the fourth half-wave plate and the fifth reflector is parallel to the beam path formed by the third polarization beam splitter, the first gain crystal element and the second reflector.

4. The apparatus of claim 3, wherein the fourth half-wave plate is replaced by a third Faraday rotator.

5. The apparatus of claim 1, wherein the first non-linear pulse amplification component comprises a third polarization beam splitter, a first gain crystal element, a second reflector, two pairs of reflective diffraction gratings, a fourth reflector, a third Faraday rotator and a fifth reflector; the third polarization beam splitter, the fifth reflector and the first pulse polarization separation component are arranged on a same straight line, and the third polarization beam splitter is located between the fifth reflector and the first pulse polarization separation component; a beam path formed by the third polarization beam splitter, the first gain crystal element and the second reflector is perpendicular to a beam path formed by the third polarization beam splitter and the fifth reflector, and the first gain crystal element is located between the third polarization beam splitter and the second reflector; the two pairs of reflective diffraction gratings are arranged between the second reflector and the fourth reflector, and a beam path formed by the fourth reflector, the third Faraday rotator and the fifth reflector is parallel to the beam path formed by the third polarization beam splitter, the first gain crystal element and the second reflector.

6. The apparatus of claim 2, wherein the third reflector is replaced by a second regeneration amplification component, and the second regeneration amplification component comprises a sixth reflector, a fourth polarization beam splitter, a fifth half-wave plate, a second pulse polarization separation component and a second non-linear pulse amplification component arranged in sequence; the fourth polarization beam splitter corresponds to the second polarization beam splitter and is located in a same column as the second polarization beam splitter; the sixth reflector is located on the same side as the first reflector, and the fifth half-wave plate and the sixth reflector are respectively located on two opposite sides of the fourth polarization beam splitter.

7. The apparatus of claim 6, wherein the second non-linear pulse amplification component comprises a second gain crystal element, a fourth Faraday rotator and a seventh reflector arranged in sequence.

8. The apparatus of claim 7, wherein the first gain crystal element and the second gain crystal element comprise laser crystals doped with ytterbium or neodymium ions.

9. The apparatus of claim 2, wherein the third reflector is replaced by a second regeneration amplification component, and the second regeneration amplification component comprises a sixth reflector, a fourth polarization beam splitter, a fifth half-wave plate, a second pulse polarization separation component and a second non-linear pulse amplification component arranged in sequence; the fourth polarization beam splitter corresponds to the second polarization beam splitter and is located in a same column as the second polarization beam splitter; the sixth reflector is located on the same side as the first reflector, and the fifth half-wave plate and the sixth reflector are respectively located on two opposite sides of the fourth polarization beam splitter.

10. The apparatus of claim 9, wherein the second non-linear pulse amplification component comprises a second gain crystal element, a fourth Faraday rotator and a seventh reflector arranged in sequence.

11. The apparatus of claim 3, wherein the third reflector is replaced by a second regeneration amplification component, and the second regeneration amplification component comprises a sixth reflector, a fourth polarization beam splitter, a fifth half-wave plate, a second pulse polarization separation component and a second non-linear pulse amplification component arranged in sequence; the fourth polarization beam splitter corresponds to the second polarization beam splitter and is located in a same column as the second polarization beam splitter; the sixth reflector is located on the same side as the first reflector, and the fifth half-wave plate and the sixth reflector are respectively located on two opposite sides of the fourth polarization beam splitter.

12. The apparatus of claim 11, wherein the second non-linear pulse amplification component comprises a second gain crystal element, a fourth Faraday rotator and a seventh reflector arranged in sequence.

13. The apparatus of claim 4, wherein the third reflector is replaced by a second regeneration amplification component, and the second regeneration amplification component comprises a sixth reflector, a fourth polarization beam splitter, a fifth half-wave plate, a second pulse polarization separation component and a second non-linear pulse amplification component arranged in sequence; the fourth polarization beam splitter corresponds to the second polarization beam splitter and is located in a same column as the second polarization beam splitter; the sixth reflector is located on the same side as the first reflector, and the fifth half-wave plate and the sixth reflector are respectively located on two opposite sides of the fourth polarization beam splitter.

14. The apparatus of claim 13, wherein the second non-linear pulse amplification component comprises a second gain crystal element, a fourth Faraday rotator and a seventh reflector arranged in sequence.

15. The apparatus of claim 5, wherein the third reflector is replaced by a second regeneration amplification component, and the second regeneration amplification component comprises a sixth reflector, a fourth polarization beam splitter, a fifth half-wave plate, a second pulse polarization separation component and a second non-linear pulse amplification component arranged in sequence; the fourth polarization beam splitter corresponds to the second polarization beam splitter and is located in a same column as the second polarization beam splitter; the sixth reflector is located on the same side as the first reflector, and the fifth half-wave plate and the sixth reflector are respectively located on two opposite sides of the fourth polarization beam splitter.

16. The apparatus of claim 15, wherein the second non-linear pulse amplification component comprises a second gain crystal element, a fourth Faraday rotator and a seventh reflector arranged in sequence.

17. The apparatus of claim 16, wherein the first gain crystal element and the second gain crystal element are identical.

18. The apparatus of claim 16, wherein the first gain crystal element and the second gain crystal element have different types of gain crystals, or have the same type of gain crystal but different cutting directions or placement angles.

19. A divided-pulse laser regeneration amplification method, comprising:
S1, inputting a signal light comprising injecting a ps-level seed pulse into a divided-pulse laser regeneration amplification component via a signal light coupling component, wherein the signal light coupling component comprises a first half-wave plate, a first polarization beam splitter, a first Faraday rotator and a second half-wave plate placed in sequence, the divided-pulse laser regeneration amplification component comprises a second polarization beam splitter and a third reflector, the second polarization beam splitter is adjacent to the second half-wave plate and is in a same column as the third reflector and the second half-wave plate; a first quarter-wave plate, a Pockels cell and a first reflector are successively arranged on a first side of the second polarization beam splitter, and a third half-wave plate, a first pulse polarization separation component and a first non-linear pulse amplification component are successively arranged on a second side of the second polarization beam splitter, the first pulse polarization separation component comprises m polarization separation components arranged at same intervals, where m≥2, each of the m polarization separation components comprises a polarization beam splitter, and a quarter-wave plate and a reflector successively arranged at each of two sides of the polarization beam splitter; and a vertical distance between two reflectors in each of the m polarization separation components increases successively in a direction from the first pulse polarization separation component to the first non-linear pulse amplification component;
S2, performing polarization, beam splitting and pulse separation on the signal light in the divided-pulse laser regeneration amplification component, wherein when performing the polarization and beam splitting on the signal light, the signal light firstly reaches the second polarization beam splitter to reflect S-polarized light, then passes through the first quarter-wave plate and the Pockels cell in sequence, and is reflected by the first reflector; a switching period of the Pockels cell is controlled in such a manner that the S-polarized light reflected by the first reflector is changed into P-polarized light after passing through the first quarter-wave plate; after the P-polarized light transmits through the second polarization beam splitter, a polarization direction of the P-polarized light is rotated by a set angle by the third half-wave plate, such that the signal light is equally divided into P-polarized light and S-polarized light to achieve beam splitting of the signal light; the polarized lights after the beam splitting are injected into the first pulse polarization separation component for pulse separation, and divided by the m polarization separation components of the first pulse polarization separation component into 2^{m} sub-pulses with orthogonal polarization between adjacent sub-pulses and with time delay between sub-pulses;
S3, amplifying the signal light, comprising injecting the sub-pulses into the first non-linear pulse amplification component, and performing twice pulse signal amplifications and rotating a polarization direction of the sub-pulses by 90° in the first non-linear pulse amplification component to obtain amplified sub-pulses, and then the amplified sub-pulses being returned along an original path;
S4, polarizing and beam-combining the amplified sub-pulses, comprising re-injecting the amplified sub-pulses into the first pulse polarization separation component for polarizing and beam-combining to obtain a single amplified pulse signal light in an S polarization state;
S5, regenerating and amplifying the single amplified pulse signal light, comprising: the amplified pulse signal light being reflected to the third reflector by the second polarization beam splitter, and reflected back to the second polarization beam splitter by the third reflector, and then successively passing through the third half-wave plate and the first pulse polarization separation component to perform the polarization, beam splitting and pulse separation, and then passing through the first non-linear pulse amplification component for amplification, and being reflected by the first non-linear pulse amplification component to the first pulse polarization separation component to perform second pulse beam-combining to obtain combined signal light which is changed back to the P-polarized state again, and then the combined signal light transmitting through the second polarization beam splitter and re-injected into the Pockels cell to complete one regeneration amplification cycle; and
S6, controlling the switching period of the Pockels cell, repeating the steps S2-S5 of the regeneration amplification cycle on the signal light until gain saturation to obtain regenerated and amplified laser pulse beam, then passing the regenerated and amplified laser pulse beam through the second half-wave plate and the first Faraday rotator of the signal light coupling component, and reflecting the regenerated and amplified laser pulse beam by the first polarization beam splitter to output the regenerated and amplified laser pulse beam.

20. The method of claim 19, wherein the third reflector is replaced by a second regeneration amplification component, wherein the second regeneration amplification component comprises a sixth reflector, a fourth polarization beam splitter, a fifth half-wave plate, a second pulse polarization separation component and a second non-linear pulse amplification component arranged in sequence; the fourth polarization beam splitter corresponds to the second polarization beam splitter and is located in a same column as the second polarization beam splitter; the sixth reflector is located on the same side as the first reflector, and the fifth half-wave plate and the sixth reflector are respectively located on two opposite sides of the fourth polarization beam splitter;
wherein after the seed pulse is injected into the divided-pulse laser regeneration amplification component via the signal light coupling component to successively subject to the pulse separation, laser amplification and beam-combining in the steps S2-S4 to obtain a combined signal light, the combined signal light is reflected to the fourth polarization beam splitter of the second regeneration amplification component by the second polarization beam splitter, and then reflected by the fourth polarization beam splitter to the fifth half-wave plate and then successively enters the second pulse polarization separation component and the second non-linear pulse amplification component to realize pulse separation and laser amplification, and sub-pulses obtained thereby are rotated by 90° in their polarizing directions; then the sub-pulses pass through the second non-linear pulse amplification component and the second pulse polarization separation component again to realize laser amplification and pulse beam-combining to obtain a combined signal light, which transmits through the fourth polarization beam splitter and reflected by the sixth reflector to transmit through the fourth polarization beam splitter again, and then successively enters the fifth half-wave plate, the second pulse polarization separation component and the second non-linear pulse amplification component for pulse separation and amplification, then reflected by the second non-linear pulse amplification component to enter the second pulse polarization separation component for amplification and pulse beam-combining again, and then reflected by the fourth polarization beam splitter back to the second polarization beam splitter and subjected to the pulse separation, laser amplification and beam-combining in the steps S2-S4 again, and then transmits through the second polarization splitter and returns back to the Pockels cell to complete one regeneration amplification cycle.
